(19) United States
(12) Patent Application Publication
(10) Pub. No.: US 2026/0333018 A1
(43) Pub. Date: Oct. 22, 2026

(54) ADAPTATION OF MULTIPLE RRC PROFILES

(71) Applicant: QUALCOMM Incorporated, San Diego, CA (US)

(72) Inventors: Navid ABEDINI, Basking Ridge, NJ (US); Jianghong LUO, Skillman, NJ (US); Tao LUO, San Diego, CA (US); Junyi LI, Greentown, PA (US); Sony AKKARAKARAN, Poway, CA (US)

(21) Appl. No.: 19/342,284

(22) Filed: Sep. 26, 2025

Related U.S. Application Data
(60) Provisional application No. 63/791,281, filed on Apr. 18, 2025.

(51) Int. Cl. H04W 8/20

(52) U.S. Cl. CPC H04W 8/20

(57) ABSTRACT

Apparatus, methods, and computer program products for wireless communication are provided. An example method may include receiving, from a network node, a set of RRC profile messages configuring a set of RRC profiles, where each RRC profile message of the set of RRC profile messages indicates a respective RRC profile of the set of RRC profiles associated with a respective feature of the UE. The example method may further include communicating with the network node based on at least one RRC profile of the set of RRC profiles.

### CROSS REFERENCE TO RELATED APPLICATION(S)

This application claims the benefit of and priority to U.S. Provisional Application Ser. No. 63/791,281, entitled “ADAPTATION OF MULTIPLE RRC PROFILES” and filed on Apr. 18, 2025, which is expressly incorporated by reference herein in its entirety.

### TECHNICAL FIELD

The present disclosure relates generally to communication systems, and more particularly, to wireless communication systems where a user equipment (UE) may be configured with multiple radio resource control (RRC) profiles.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) receive, from a network node, a set of radio resource control (RRC) profile messages configuring a set of RRC profiles, where each RRC profile message of the set of RRC profile messages indicates a respective RRC profile of the set of RRC profiles associated with a respective feature of the UE. Based at least in part on information stored in the at least one memory, the at least one processor, individually or in any combination, is configured to communicate with the network node based on at least one RRC profile of the set of RRC profiles.

In another aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor, individually or in any combination, is configured to transmit, for a user equipment (UE), a set of radio resource control (RRC) profile messages configuring a set of RRC profiles, where each RRC profile message of the set of RRC profile messages indicates a respective RRC profile of the set of RRC profiles associated with a respective feature of the UE. Based at least in part on information stored in the at least one memory, the at least one processor, individually or in any combination, is configured to communicate with the UE based on at least one RRC profile of the set of RRC profiles.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating example radio resource control (RRC) profiles under a common adaptation framework, in accordance with various aspects of the present disclosure.

FIG. 5 is a diagram illustrating example communications between a network entity and a UE, in accordance with various aspects of the present disclosure.

FIG. 6 is a flowchart of a method of wireless communication, in accordance with various aspects of the present disclosure.

FIG. 7 is a flowchart of a method of wireless communication, in accordance with various aspects of the present disclosure.

FIG. 8 is a diagram illustrating an example of a hardware implementation for an example apparatus and/or network entity, in accordance with various aspects of the present disclosure.

FIG. 9 is a diagram illustrating an example of a hardware implementation for an example network entity, in accordance with various aspects of the present disclosure.

FIG. 10 is a flowchart of a method of wireless communication, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

In some wireless communication systems, some parameters may be configured through radio resource control (RRC) and may be activated, deactivated, or adapted using lower-layer signaling or event-based triggers. Examples of such features include secondary cells (SCells), bandwidth parts (BWPs), cell-level discontinuous transmission or reception, and on-demand synchronization signal blocks (SSBs) for secondary cells. Each of these functions may have its own independent mechanism for activation or deactivation at the lower layer or based on specific events. However, there are parameters and features that may not support lower-layer or event-driven adaptation, and may instead be reconfigured through RRC procedures. When introducing new features to the wireless communication system, there may be no adaptation mechanisms that may be applicable, and each new feature may use an adaptation mechanism in a standalone fashion. Aspects provided herein may enable a unified and future-proof framework for configuration and adaptation of RRC parameters based on a common framework for dynamic adaptation based on lower-layer signaling or event-based triggers across one or multiple RRC profiles. Each of the RRC profiles may flexibly include different combination of RRC parameters and may be associated with a respective feature. Aspects herein may present a unified and future-proof framework for configuring and adapting parameters, featuring dynamic switching among pre-defined RRC configurations through lower-layer signaling and event triggers. This framework includes RRC profile messages for flexible parameter configuration, a MAC-CE framework for adaptation, Layer 1-based activation, and an event-based adaptation framework.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

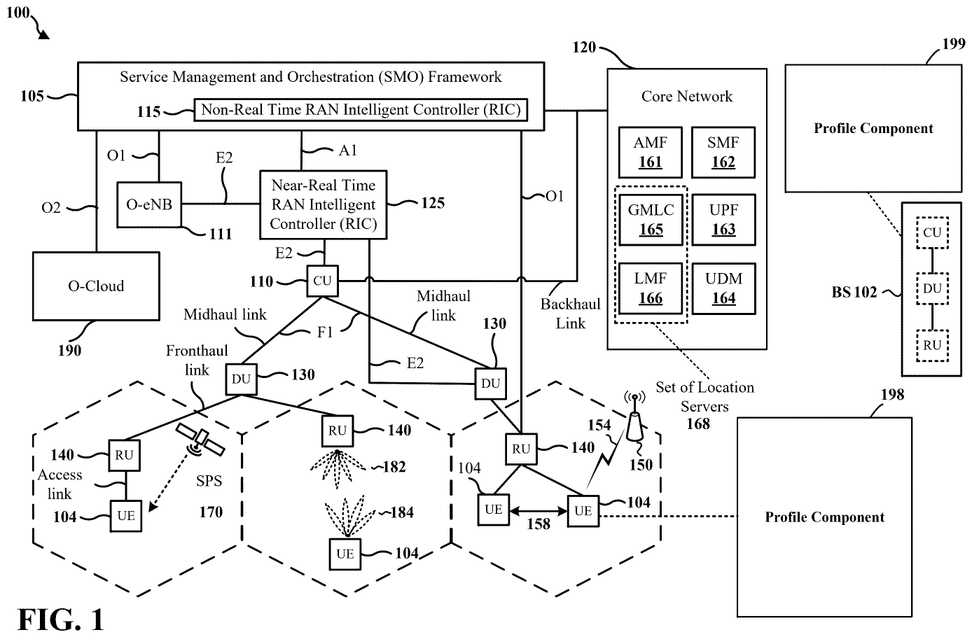

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a profile component 198. In some aspects, the profile component 198 may be configured to receive, from a network node, a set of RRC profile messages configuring a set of RRC profiles, where each RRC profile message of the set of RRC profile messages indicates a respective RRC profile of the set of RRC profiles associated with a respective feature of the UE. In some aspects, the profile component 198 may be further configured to communicate with the network node based on at least one RRC profile of the set of RRC profiles.

In certain aspects, the base station 102 may include a profile component 199. In some aspects, the profile component 199 may be configured to transmit, for a UE, a set of RRC profile messages configuring a set of RRC profiles, where each RRC profile message of the set of RRC profile messages indicates a respective RRC profile of the set of RRC profiles associated with a respective feature of the UE. In some aspects, the profile component 199 may be further configured to communicate with the UE based on at least one RRC profile of the set of RRC profiles.

Although the following description may be focused on 5G NR, the concepts described herein may be applicable to other similar areas, such as 6G, LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

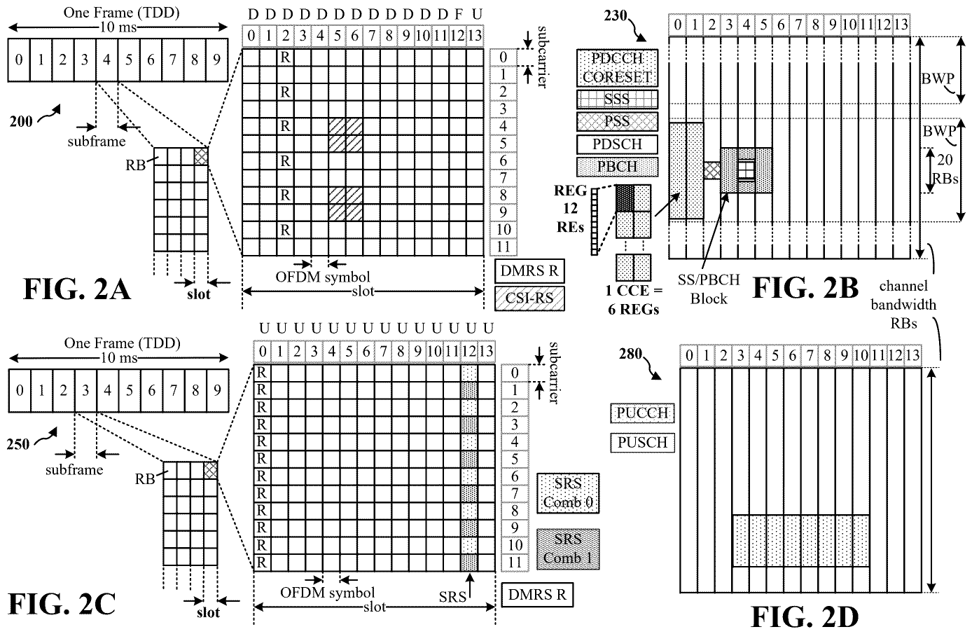

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 24*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

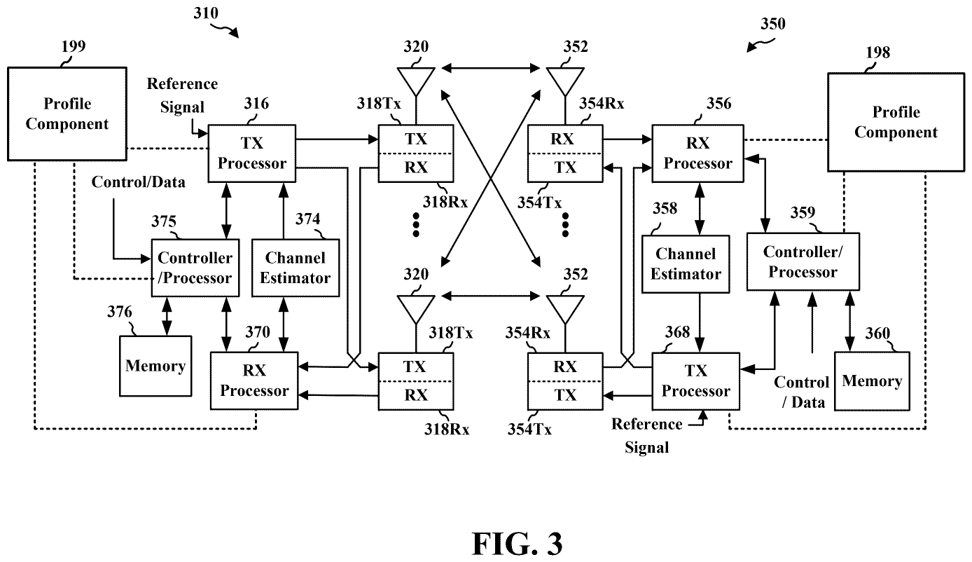

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with profile component 198 of FIG. 1.

At least one of the TX processor 316, the RX processor 370, and the controller/processor 375 may be configured to perform aspects in connection with profile component 199 of FIG. 1.

In some wireless communication systems, some parameters may be configured through radio resource control (RRC) and may be activated, deactivated, or adapted using lower-layer signaling or event-based triggers. Examples of such features include secondary cells (SCells), bandwidth parts (BWPs), cell-level discontinuous transmission or reception, and on-demand synchronization signal blocks (SSBs) for secondary cells. Each of these functions may have its own independent mechanism for activation or deactivation at the lower layer or based on specific events. However, there are parameters and features that may not support lower-layer or event-driven adaptation, and may instead be reconfigured through RRC procedures. When introducing new features to the wireless communication system, there may be no adaptation mechanisms that may be applicable, and each new feature may use an adaptation mechanism in a standalone fashion. Aspects provided herein may enable a unified and future-proof framework for configuration and adaptation of RRC parameters based on a common framework for dynamic adaptation based on lower-layer signaling or event-based triggers across one or multiple RRC profiles. Each of the RRC profiles may flexibly include different combination of RRC parameters and may be associated with a respective feature. Each RRC profile may be configured to the UE based on a respective RRC profile message, where one or more RRC profile message(s) may be included in a single signaling.

As used herein, the term “RRC profile” may refer to a collection of RRC parameters associated with at least one feature of the UE that may be stored by the UE on a per-RRC profile basis and may be activated or deactivated. An RRC profile may be referred to as “activated” if the UE uses the RRC profile for communications related to the at least one feature that the RRC profile is associated to. In some aspects, activation or deactivation of RRC profiles may be based on signaling from the network node such as downlink control information (DCI) or medium access control (MAC) control element (MAC-CE). In some aspects, activation or deactivation of RRC profiles may be based on particular “events” that may be defined based on: (1) absolute or relative channel/beam quality and strength, (2) counts of some incidents (such as beam failure or block error rate (BLER) crossing a threshold) within an indicated/configured time window, (3) buffer status, power headroom, mobility state, inactivity timers, or the like, or (4) defined based on a combination of one or more channel related conditions or UE conditions. In some aspects, an activation or deactivation method (e.g., whether signaling-based or event-based, or particular events associated with activation/deactivation) associated with an RRC profile may be configured in the RRC profile message that includes the RRC profile. In some aspects, to ensure synchronicity between the network node and the UE, the UE may indicate to the network node regarding the RRC profiles being activated, deactivated, or deleted (e.g., due to being no longer valid).

As used herein, the term “feature” may refer to one or more particular logical channels, one or more particular configurations, or one or more procedures at the UE related to different state of the UE. For example, different RRC profiles may be associated with different semi-static/periodic channels such as any combination of PDCCH monitoring occasions, scheduling request (SR), sounding reference signal (SRS), CSI-RS, semi-persistent scheduling (SPS), configured grant (CG)-PUSCH, SSB/SIB/RACH with longer periodicity or on-demand SSB/SI, CSI-RS configuration, measurement configuration, different cells, different groups of cells, different areas, different UE groups, different states (e.g., dormant state, active state, or semi-active state) of different SCells, whether the UE is experiencing a bursty (e.g., a data volume higher than a threshold) traffic session for a particular quality of service (QoS), different procedures at the UE such as CSI-RS, measurement, SR, RACH, or the like. In some aspects, each RRC profile may be associated with a particular applicable time period or a particular applicable area where the RRC profile may be no longer applicable outside the applicable time period or if the UE is outside the applicable area. In some aspects, each RRC profile may be associated with a validity timer or a validity area where the RRC profile may be deleted by the UE if the validity timer expires or the UE is outside the validity area. In some aspects, the UE may store RRC profiles and may receive update on individual RRC profiles. The UE may also share RRC profile(s) with other UEs (e.g., and share associated profile IDs) and the RRC profiles associated with a UE may be transferred from one network node to another as part of mobility.

The UE may be configured with multiple RRC profiles and may have at least one RRC profile of the multiple RRC profiles activated. Different RRC profiles may each separately include a respective set of RRC parameters. In some aspects, there may be no overlap between the respective set of RRC parameters included in the different RRC profiles. In some aspects, there may be overlap(s) between the respective set of RRC parameters included in the different RRC profiles, and the values of the overlapped RRC parameters may be the same or may be different.

In some aspects, when the values of the overlapped RRC parameters may be different across different RRC profiles, to resolve potential conflicts (e.g., in the scenario where multiple RRC profiles may be applicable), each RRC profile may be associated with a respective profile priority, where the UE may use the value configured in the RRC profile with the higher profile priority. In some aspects, an RRC profile may refer to another RRC profile with regard to particular RRC parameters in the RRC profile. For example, a first RRC profile may configure an example parameter that refers to a value configured in a second RRC profile. In some aspects, the second RRC profile may be explicitly referenced by the first RRC profile by including an identifier (ID) associated with the second RRC profile in a field related to the referred parameter(s). In some aspects, the second RRC profile may be a default (which may be otherwise referred to as “baseline”) RRC profile which the first RRC profile may refer to implicitly (e.g., by not including a value for a configured RRC parameter so that using the default RRC profile for the configured parameter is implied). In some aspects, instead of or in addition to directly using the value configured in the second RRC profile, the first RRC profile may indicate a differential value that indicates a difference between the value configured for a particular RRC parameter in the second RRC profile and the same configured for the same particular RRC parameter in the first RRC profile.

In some aspects, example RRC parameters that may be included in a particular RRC profile may include various RRC parameters in any combination. For example, for BWP management associated with a particular feature, the RRC parameters may include a default DL BWP ID (e.g., represented by information element (IE) defaultDownlinkBWP-Id), an active DL BWP ID (e.g., represented by IE firstActiveDownlinkBWP-Id), a default UL BWP ID (e.g., represented by IE defaultUplinkBWP-Id), an inactivity timer for BWP switching (e.g., represented by IE bwp-InactivityTimer), or time-domain resource assignment per BWP (e.g., represented by IE timeDomainAllocationList). For uplink scheduling in a particular RRC profile, the RRC parameters may include a scheduling request ID (e.g., represented by IE schedulingRequestId), a prohibit timer for scheduling requests (e.g., represented by IE sr-ProhibitTimer), the configured uplink grant (e.g., represented by IE configuredGrantConfig), and parameters for HARQ such as number of processes (e.g., represented by IE numberOfHARQ-ProcessesForPUSCH) and re-transmission timers (e.g., represented by reTxTimerHARQ). For mobility management, the RRC parameters may include a measurement object ID (e.g., represented by IE measObjectId), measurement quantities like reference signal received power (e.g., represented by IE quantityConfig-rsrp), report configuration ID (e.g., represented by IE reportConfigId), and event thresholds for triggering measurements, such as an event A3 offset (e.g., represented by a3-Offset) or event A5 thresholds (e.g., represented by threshold1, threshold2). Conditional handover may be configured through a target cell identifier (e.g., represented by condHO-TargetCell), an offset for the triggering condition (e.g., represented by condHO-Offset), and the activation time (e.g., represented by condHO-ActivationTime). For discontinuous reception (DRX), RRC parameters may include an on-duration timer (e.g., represented by IE onDurationTimer), an inactivity timer (inactivityTimer), a short DRX cycle (e.g., represented by IE shortDRX-Cycle), and a retransmission timer (e.g., represented by IE drx-RetransmissionTimer). Power control may be configured using a nominal PUSCH power parameter (p0-NominalWithGrant), a path loss compensation factor (e.g., represented by IE alpha), and a pathloss reference resource set (e.g., represented by IE pathlossReferenceRS-Set).

Carrier aggregation and dual connectivity may involve parameters such as a secondary cell index (e.g., represented by IE sCellIndex), a serving cell index (e.g., represented by IE servCellIndex), and activation or deactivation commands for each secondary cell. The configuration of demodulation reference signal ports may be defined by a maximum number of downlink layers (e.g., represented by IE maxNumberMIMO-Layers), the type of transmission precoding matrix indicator (e.g., represented by IE precodingResourceSet), and the demodulation reference signal port set (e.g., represented by IE dmrs-TypeA-Position and dmrs-AdditionalPosition).

Security configurations may include a ciphering algorithm (e.g., represented by IE cipheringAlgorithm), an integrity protection algorithm (e.g., represented by IE integrityProtAlgorithm), and the overall security algorithm configuration (e.g., represented by IE securityAlgorithmConfig). Initial access and random access procedures may use parameters such as a preamble index (e.g., represented by IE rach-PreambleIndex), a PRACH configuration index (e.g., represented by IE prach-ConfigIndex), and a time-domain allocation for Msg3 (e.g., represented by IE msg3-DeltaPreamble).

For PDCCH monitoring occasions, the RRC parameters may include a control resource set ID (e.g., represented by IE controlResourceSetId), a monitoring slot offset (e.g., represented by IE monitoringSlotPeriodicityAndOffset), and the monitoring periodicity (e.g., represented by IE monitoringSymbols WithinSlot). For SR, the RRC parameters may include an SR periodicity (e.g., represented by IE sr-Periodicity), the resources for SR (e.g., represented by IE sr-Resource), and a maximum quantity of SR transmissions (e.g., represented by IE maxNumSR-Transmissions). For SRS, the RRC parameters may include a periodicity (e.g., represented by IE srs-Periodicity), a transmission comb configuration (e.g., represented by IE srs-CombOffset), and a resource set index (e.g., represented by IE srs-ResourceId). For CSI-RS, the RRC parameters may include the CSI resource ID (e.g., represented by IE csi-ResourceId), the periodicity (e.g., represented by IE csi-ResourcePeriodicityAndOffset), and the CSI report triggering condition (e.g., represented by IE reportTriggerSize or resourceConfigToAddModList).

For SPS, the RRC parameters may include a configured SPS periodicity (e.g., represented by IE semiPersistentSchedInterval), an activation or deactivation indication (e.g., represented by IE sps-ActivationTimer), and the number of repetitions (e.g., represented by IE numberOfRepetitions). For CG-PUSCH, the RRC parameters may include the CG configuration index (e.g., represented by IE cg-ConfigIndex), periodicity (e.g., represented by IE cg-Periodicity), time domain assignment (e.g., represented by IE timeDomainAllocation), and uplink power control parameters (e.g., represented by IE p0-NominalWithGrant).

For SSB/SIB or RACH with long periodicity or on-demand configuration, parameters may include an SSB periodicity (e.g., represented by IE ssb-PeriodicityServingCell), a system information request triggering configuration (e.g., represented by IE si-RequestConfig), and a PRACH configuration index (e.g., represented by IE prach-ConfigIndex). For a bursty traffic session, an associated RRC profile may include a discontinuous reception settings and grant-free uplink that may be adjusted using timers such as the on-duration timer (e.g., represented by IE onDurationTimer) and the DRX inactivity timer (e.g., represented by IE drx-InactivityTimer). In some aspects, measurement configurations may include parameters such as event-triggered thresholds (e.g., represented by IE eventId with a3-Offset or a5-Thresholds), measurement gaps (e.g., represented by IE gapId, gapOffset), and the reporting configuration (e.g., represented by IE reportConfigId) to support mobility management and signal quality evaluation.

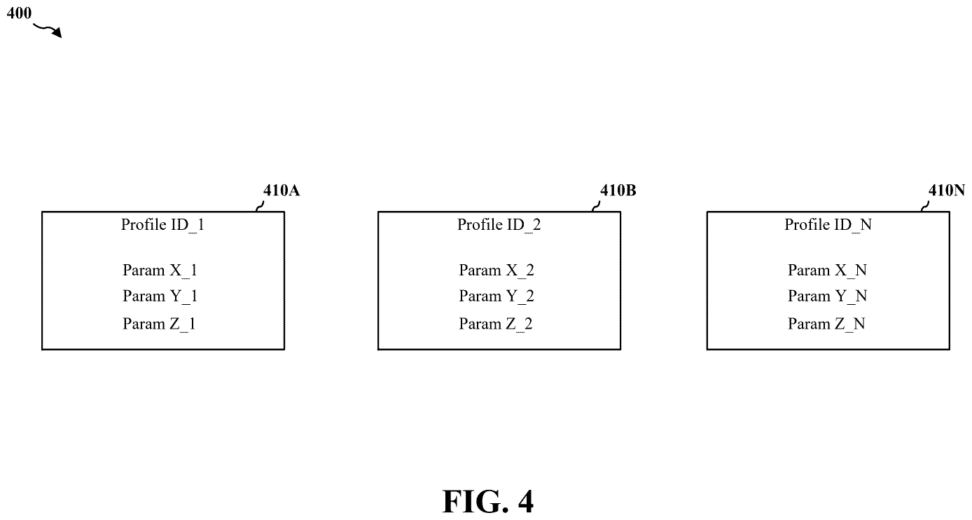

FIG. 4 is a diagram 400 illustrating example RRC profiles under a common adaptation framework, in accordance with various aspects of the present disclosure. As illustrated in FIG. 4, the UE may receive a first RRC profile 410A, a second RRC profile 410B, and one or more additional RRC profiles including a Nth RRC profile 410N from a network node in respective RRC profile messages. Each of the first RRC profile 410A, the second RRC profile 410B, and the Nth RRC profile 410N may include a respective set of RRC parameters. For example, the first RRC profile 410A may include a first RRC parameter Param X_1, a second RRC parameter Param Y_1, and a third RRC parameter Param Z_1. The second RRC profile 410B may include a first RRC parameter Param X_2, a second RRC parameter Param Y_2, and a third RRC parameter Param Z_2. The Nth RRC profile 410N may include a first RRC parameter Param X_N, a second RRC parameter Param Y_N, and a third RRC parameter Param Z_N. The parameters in the first RRC profile 410A, the second RRC profile 410B, and the Nth RRC profile 410N may be the same RRC parameters with a same or different values, or different RRC parameters.

In some aspects, the network may be able to create different profiles tailored for different purposes or use-cases. For example, there may be one or more RRC profiles for network energy saving that includes a configuration with less network signaling or a cancelation of some of the semi-static/periodic channels (such as any combination of PDCCH monitoring occasions, SR, SRS, CSI-RS, SPS, CG-PUSCH, SSB/SIB/RACH with longer periodicity or on-demand SSB/SI, or the like) for one or multiple cells associated with the network node. In some aspects, there may be one or more RRC profiles for SCell's semi-active, dormant state, or semi-dormant state. In some aspects, there may be one or more RRC profiles for accommodating a bursty traffic session with its associated QoS that may be activated and deactivated (when the traffic is served). In some aspects, there may be one or more RRC profiles for specific procedures such as CSI-RS configuration, or measurement configuration, SR configuration, RACH configuration, SSB adaptation, or the like.

In some aspects, the UE may receive one or more RRC profile messages where each RRC profile message may include an RRC profile for an RRC configuration of any combination of parameters. In some aspects, the RRC profile message may be or may be similar to an RRC reconfiguration messages. In some aspects, at least one of the one or more RRC profiles may be active (e.g., activated) for the UE. In some aspects, each RRC profile may be associated with an RRC profile ID.

In some aspects, for more efficient configuration signaling and reducing the memory usage at the UE, an RRC profile may be configured to inherit configurations from one or multiple other profiles to enable skipping configuration of some parameters and use the value(s) from the parent profile(s). In some aspects, each profile message may include ID of such parent profile(s). In some aspects, there may be at least one default or baseline RRC profile where the other RRC profiles may implicitly use the values configured in the default or baseline RRC profile without explicitly referencing the RRC profile ID. In some aspects, for different parameters/procedures, different parent profile IDs may be indicated. In some aspects, in absence of explicitly indicated/configured parent or default profile, the UE may use the latest configured parameters (e.g., from a previously indicated/activated profile) as default values.

In some aspects, each RRC profile or parent/reference RRC profile may be associated with an indicated priority. In some aspects, the priority may be defined across profiles. For example, when profiles with overlapping configured parameters are activated/applied, the priority can be used to decide which profile may (e.g., partially on the overlapped parameters) override the other one. In another example, when multiple parent profiles are configured for inheritance purposes, and there is a conflict for some overlapping parameters, the priority may be used for conflict resolution.

Within a profile, different sets of parameters may be associated with their priority value/flag. Such a priority value/flag may be used for overriding purposes as well. In some aspects, to resolve the conflict in case of inheritance from multiple parent profiles (with partial conflict), the order in which the parent profile IDs are listed may be used. In some aspects, the UE may declare or report an error case when a conflict occurs. In some aspects, there may be self-reference/close-loops of inheritance (e.g., profile A inherits from profile B, while profile B inherits from profile A) and the UE may also declare or report an error a case when such a scenario occurs.

In some aspects, an RRC profile may be UE-specific, cell-specific, area-specific, or applicable to a group of cells and/or frequencies. In some aspects, an RRC profile may be configured with a validity timer or a validity area where upon expiry of the profile based on the validity timer or the validity area, the UE may remove the profile from its storage and may attempt (to connect to) acquire new profile(s). In some aspects, the validity timer may be updated/extended upon UE's notification of the expiry, or proactively by the network (via dedicated/broadcast/multicast indication). In some aspects, the validity area may also be updated/extended.

In some aspects, an RRC profile may be associated with one or more RRC states such as connected, inactive or idle and an RRC profile may be defined to be associated with each individual mode, and different procedures in different modes (e.g., SSB/RACH/TRS/paging/SI/CPE) may be associated with different RRC profiles.

In some aspects, the RRC profile(s) may be configured based on dedicated RRC signaling, SIB (e.g., when profiles are applicable to idle-mode procedures), a broadcast channel that can be received by UEs (e.g., in all RRC states), a user plane message, over-the-top (OTT) message, AI agents, broadcasted by a particular relevant cell periodically or on-demand, or the like. In some aspects, the network node may broadcast (e.g., in SIB) the RRC profile IDs associated with itself and/or one or more neighbor cells/frequencies periodically or on-demand.

In some aspects, based on UE's location or predicted trajectory, multiple RRC profiles may be provided to the UE in-advance, and each profile may be further associated with an applicable time period or location/area. In some aspects, a UE may share the list of stored profile IDs (along with version ID or timestamps) and the network may provide a delta profile that indicates specific updates of the UE's stored RRC profile(s). In some aspects, one network node may transfer RRC profile(s) specific to a UE to another network node to facilitate handover or other operations between the UE and the other network node. For example, there may be backhaul signaling for exchanging information about the UE's profile at the source cell, admission of UE's profile, suggestion to change some part of UE's profile, early delivery of potentially adjusted UE's profile for the target cell.

In some aspects, RRC profiles for different purposes may be dependent on each other. For example, an NES profile and an SCell profile may be correlated. In some aspect, RRC profile group(s) may be indicated to group related RRC profiles with each other.

In some aspects, the UE may indicate, in a capability signaling, the quantity and the types of supported RRC profiles and the network node may also indicate whether and the type(s) of RRC profiles that the network node (or each cell at the network node) may support or configure.

In some aspects, each RRC profile message may be associated with a configurable method of activation/adaptation. In some aspects, whether the configuration is applicable/active at the time of configuration, or layer 1 (L1) and/or layer 2 (L2)-based (de) activation/adaptation may be supported, and/or event-based activation may be supported may be indicated for the UE.

In some aspects, each RRC profile may be associated with a configurable timeline for (de) activation or adaptation where such a timeline can be different for different methods of (de) activation or adaptation. In some aspects, deactivation of an RRC profile may be reverting the associated configured parameter values to a default value that may be, by way of example, based on the values of an active BWP or a default BWP, specified default value for each IE, or values before the profile was activated. In some aspects, the UE may transmit an indication of readiness for one or more RRC profile IDs. For example, when at least one profile is indicated to be adapted, the UE may send a notification when the UE has successfully activated/adapted the profile ID(s).

In some aspects, an example MAC-CE for activation of RRC profile(s) may be associated with a specified/configured logical channel ID and may include a list of one or multiple profile IDs. In some aspects, the example MAC-CE may indicate the RRC profiles to be activated or to be deactivated. In some aspects, the example MAC-CE may include a timeline for (de) activation (such a timeline may also be configured as part of RRC profile itself). In some aspects, there may be an indicated/configured mapping from logical channel ID(s) to the configured/types of RRC profiles. In some aspects, multiple profiles with the same or different timelines may be indicated in the same MAC-CE.

In some aspects, a DCI may be used for (de) activation of one or multiple profile ID(s). In some aspects, there may be a mapping from one or multiple profile IDs to one or multiple resources (searchspace, CORESETs, or the like), RNTIs, and/or bit locations within a DCI payload. In some aspects, the mapping may be provided by RRC (e.g., as part of configuration of the RRC profile) or MAC-CE. In some aspects, the network may can configure a total of K profiles via RRC, activate M smaller than K profiles via MAC-CE and indicate one or N smaller M via DCI, where each of K, N, and M is a positive integer. In some aspects, the DCI may be a group-common DCI, or a dedicated DCI. In some aspects, the DCI may be configured to have associated HARQ feedback or not have associated HARQ feedback.

In some aspects, for event-based activation/deactivation, events or timers associated with (de) activation of different profile (IDs) or switching between them may be configured. In some aspects, events may be defined based on absolute/relative channel/beam quality and strength (based on example metrics such a reference signal received power (RSRP), a received signal strength indicator (RSSI), a signal to interference and noise ratio (SINR), a channel quality indicator (CQI), a quantity of layers, or an estimated spectral efficiency). In some aspects, event may be defined based counts of some incidents (such as beam failure or BLER crossing a threshold) within some indicated/configured time window. In some aspects, events may be based on buffer status, power headroom, mobility state, inactivity timers. In some aspects, events may be flexibly defined using configurations (such as software-defined/downloadable). When an event occurs, the UE may follow a configured rule to adapt/change a profile, and it may further indicate its change to the network node. In some aspects, the UE may report the event and upon receiving an explicit/implicit ACK from the network, the UE may adapt/change the profile following the configured instruction. In some aspects, the UE may report the event and wait for the NW to indicate adaptation.

In some aspects, one or more RRC profiles may be defined to be relevant/applicable to idle/inactive-mode procedures. (e.g., related to SSB/RACH/TRS/paging/SI, or for CPE-specific optimizations. For such RRC profiles, adaptation (e.g., activation or deactivation) may be based on L1 signaling such as sequence or DCI-based (e.g., using PEI, LP-WUS, paging PDCCH, or other newly defined DCI, or sequences), or the MAC-CE that may be indicated in the payload of a broadcast PDSCH channel (scrambled with a configured/indicated group/broadcast RNTI).

In some aspects, to ensure synchronicity between network and UE, the network node or the UE may send an inquiry about its current assumption of the activated/applicable profile ID(s) and accordingly receive a response. In some aspects, the network node or the UE may be configured to periodically indicate its status (e.g., regarding currently activated/applicable RRC profile ID(s)). In some aspects, in the capability indication, the UE may indicate support for the indicated/configured profiles and a minimum application time with regard to activation or deactivation of an RRC profile for a particular activation method.

In some aspects, a conflicting scenario may show up when two profiles are activated (e.g., using same or separate MAC-CE) with same/overlapping timeline and conflicting settings for a specific RRC parameter IE. To resolve the conflict, in some aspects, profile may be configured/indicated with a priority flag/value. In some aspects, conflict resolution can be based on order in which the profiles are listed in the DCI or the MAC-CE, or in case of two separate signaling, based on CCE-index of scheduling PDCCH carrying the DCI or the MAC-CE. In some aspects, within a profile, different sets of parameters may be associated with their respective priority value/flag. In some aspects, such a priority value/flag may be across different methods of adaptation/reconfiguration. For example, whether L1/L2 indication can override the RRC-configured value may be indicated.

In some aspects, the priority value/tag can be dynamically indicated/updated (e.g., as part of the same L1/L2 signaling used for activation/adaptation, or a separate indication). In some aspect, the change indication may be valid for an indicated duration (or area), or until next notice. In some aspects, the indication may overwrite a previous assumption/indication of the priority for the associated profile.

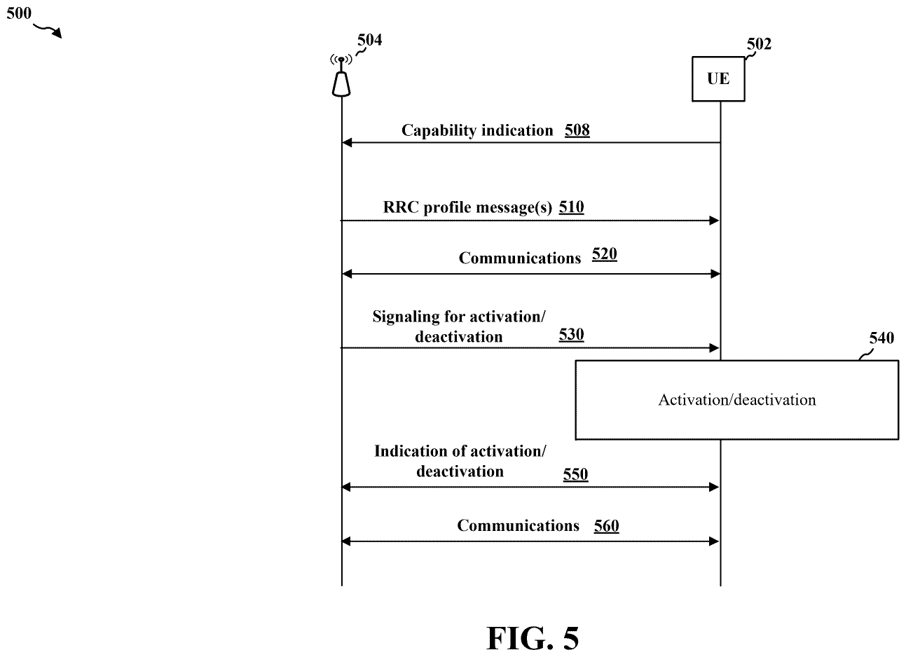

FIG. 5 is a diagram 500 illustrating example communications between a network node 504 and a UE 502, in accordance with various aspects of the present disclosure.

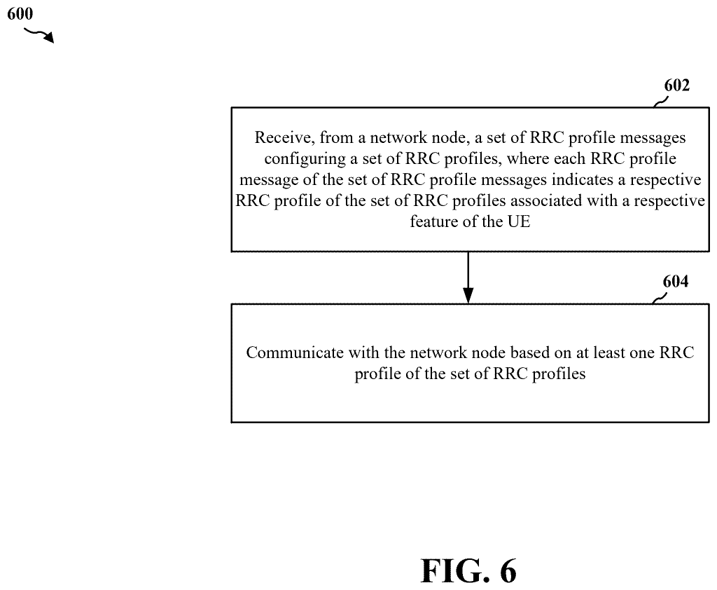

As illustrated in FIG. 5, the UE 502 may indicate a capability indication 508 to indicate support of multiple RRC profiles (e.g., quantity and type of RRC profiles supported). The UE 502 may receive, from the network node 504, a set of RRC profile messages 510 configuring a set of RRC profiles, where each RRC profile message of the set of RRC profile messages indicates a respective RRC profile of the set of RRC profiles associated with a respective feature of the UE 502. At 520, the UE 502 may communicate with the network node 504 based on at least one RRC profile of the set of RRC profiles. In some aspects, at 540, the UE 502 may activate or deactivate one or more RRC profiles, where the activation or the deactivation may be based on a signaling 530 (e.g., a DCI or MAC-CE) from the network node 504, or based on one or more events. In some aspects, the method of activation/deactivation associated with the RRC profiles may be included in the set of RRC profile messages 510 or otherwise configured to the UE 502. In some aspects, after activation/deactivation at 540, the UE 502 and the network node 504 may communicate indication(s) of the currently active/inactive RRC profiles at 550. In some aspects, the UE 502 and the network node 504 may further communicate based on the currently active RRC profiles at 560. FIG. 6 is a flowchart 600 of a method of wireless communication. The method may be performed by a UE (e.g., the UE 104, the UE 502; the apparatus 804).

At 602, the UE may receive, from a network node, a set of RRC profile messages configuring a set of RRC profiles, where each RRC profile message of the set of RRC profile messages indicates a respective RRC profile of the set of RRC profiles associated with a respective feature of the UE. For example, the UE 502 may receive, from a network node 504, a set of RRC profile messages (e.g., 510) configuring a set of RRC profiles, where each RRC profile message of the set of RRC profile messages indicates a respective RRC profile of the set of RRC profiles associated with a respective feature of the UE. In some aspects, 602 may be performed by profile component 198.

In some aspects, the set of RRC profiles includes a first RRC profile associated with one or more semi-static or periodic channels, a second RRC profile associated with a semi-active or dormant state associated with a secondary cell, a third RRC profile associated with a burst traffic session associated with a QoS, or a fourth RRC profile associated with a non-burst traffic session. In some aspects, the respective feature corresponds to: a CSI-RS configuration, a measurement configuration, a scheduling request configuration, or a random access channel configuration RACH. In some aspects, each RRC profile message of the set of RRC profile messages indicates a respective profile ID associated with the respective RRC profile, and where a first RRC profile message of the set of RRC profile messages indicates a first profile ID associated with a first RRC profile and a parent profile ID associated with the first profile ID, where the parent profile ID is associated with a second RRC profile.

In some aspects, the first RRC profile includes a first set of RRC parameters and the second RRC profile includes a second set of RRC parameters configured to be used in connection with the first set of RRC parameters. In some aspects, the first RRC profile includes a first set of values for the first set of RRC parameters and the second RRC profile includes a second set of values for the first set of RRC parameters.

In some aspects, each RRC profile message of the set of RRC profile messages indicates a respective profile ID associated with the respective RRC profile, where a first RRC profile message of the set of RRC profile messages indicates a first profile ID associated with a first RRC profile, where the first RRC profile includes a first set of RRC parameters and a second RRC profile includes a second set of RRC parameters configured to be used in connection with the first set of RRC parameters, and where the second RRC profile is a common parent RRC profile associated with the set of RRC profiles. In some aspects, each RRC profile message of the set of RRC profile messages indicates at least one respective profile priority associated with the respective RRC profile for override of conflicting values of a same RRC parameter included in different RRC profiles of the set of RRC profiles, and where the at least one respective profile priority is associated with the respective RRC profile or associated with at least one particular RRC parameter of the respective RRC profile.

In some aspects, an RRC profile of the set of RRC profiles is associated with a validity timer or a validity area, and the UE may remove the RRC profile from the at least one memory based on an expiration of the validity timer or a movement of the UE outside the validity area. In some aspects, the UE may receive, from the network node, an update on the validity timer or the validity area. In some aspects, an RRC profile of the set of RRC profiles is UE-specific and associated with the UE, cell-specific and associated with one or more cells of the network node, or area-specific and associated with a current area that the UE is in. In some aspects, the UE may receive the set of RRC profile messages in a system information block (SIB), a dedicated RRC signaling, a broadcast channel, or a user plane message. In some aspects, each RRC profile of the set of RRC profiles is associated with a respective applicable time period or a respective applicable location.

In some aspects, the UE may activate (e.g., 540) the at least one RRC profile of the set of RRC profiles, where each RRC profile message of the set of RRC profile messages indicates a respective activation method associated with the respective RRC profile. In some aspects, at least one of the respective activation method corresponds to medium access control (MAC) control element (MAC-CE)-based activation or downlink control information (DCI)-based activation, and the UE may receive a MAC-CE or DCI (e.g., 530) that indicates the at least one RRC profile. In some aspects, the MAC-CE or the DCI further indicates at least one timeline associated with the at least one RRC profile or a mapping between the at least one RRC profile to at least one logical channels.

In some aspects, at least one of the respective activation method corresponds to event-based activation based on an event. In some aspects, the event is based on at least one of: (1) an indication of a channel or beam quality or strength based on a reference signal received power (RSRP), a received signal strength indicator (RSSI), a signal to interference and noise ratio (SINR), a channel quality indicator (CQI), a quantity of layers, or an estimated spectral efficiency, (2) a beam failure or a block error rate above a threshold within a window, (3) a buffer status, (4) a power headroom, (5) a mobility state associated with the UE, or (6) one or more timers. In some aspects, the UE may transmit an indication (e.g., 550) of the at least one RRC profile to the network node.

At 604, the UE may communicate with the network node based on at least one RRC profile of the set of RRC profiles. For example, the UE 502 may communicate (e.g., 520 or 560) with the network node 504 based on at least one RRC profile of the set of RRC profiles. In some aspects, 604 may be performed by profile component 198. In some aspects, the UE may communicate with the network node based on the first set of values for a first feature associated with the first RRC profile (e.g., 410A). In some aspects, the UE may communicate with the network node based on the second set of values for a second feature different from the first feature.

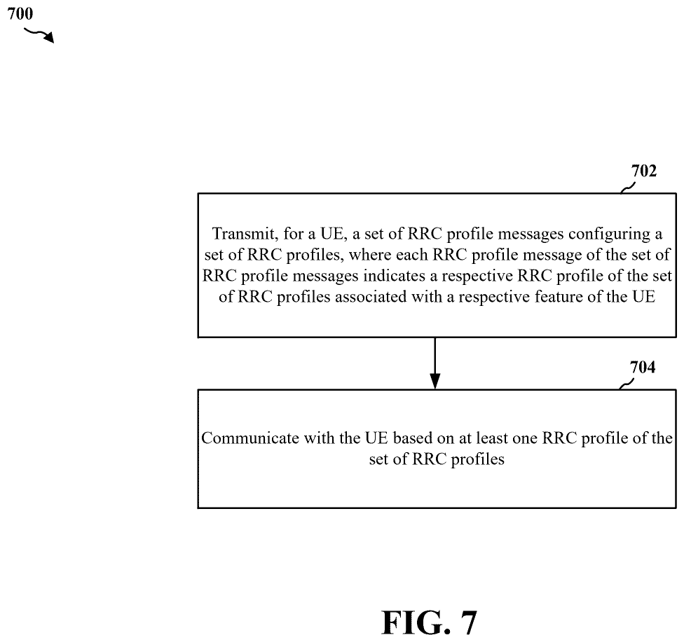

FIG. 7 is a flowchart 700 of a method of wireless communication. The method may be performed by a network node (e.g., the base station 102, the network entity 802, the network entity 902).

At 702, the network node may transmit, for a UE, a set of RRC profile messages configuring a set of RRC profiles, where each RRC profile message of the set of RRC profile messages indicates a respective RRC profile of the set of RRC profiles associated with a respective feature of the UE. For example, the network node 504 may transmit, for a UE 502, a set of RRC profile messages (e.g., 510) configuring a set of RRC profiles, where each RRC profile message of the set of RRC profile messages indicates a respective RRC profile of the set of RRC profiles associated with a respective feature of the UE. In some aspects, 702 may be performed by profile component 199.

At 704, the network node may communicate with the UE based on at least one RRC profile of the set of RRC profiles. For example, the network node 504 may communicate (e.g., 520 or 560) with the UE (e.g., 502) based on at least one RRC profile of the set of RRC profiles. In some aspects, 704 may be performed by profile component 199.

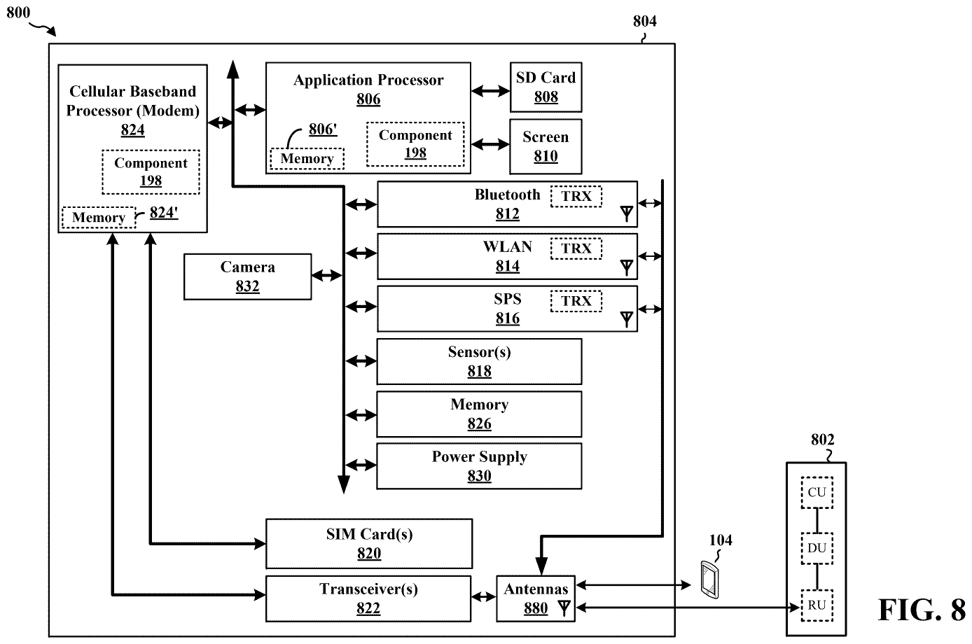

FIG. 8 is a diagram 800 illustrating an example of a hardware implementation for an apparatus 804. The apparatus 804 may be a UE, a component of a UE, or may implement UE functionality. In some aspects, the apparatus 804 may include at least one cellular baseband processor 824 (also referred to as a modem) coupled to one or more transceivers 822 (e.g., cellular RF transceiver). The cellular baseband processor(s) 824 may include at least one on-chip memory 824′. In some aspects, the apparatus 804 may further include one or more subscriber identity modules (SIM) cards 820 and at least one application processor 806 coupled to a secure digital (SD) card 808 and a screen 810. The application processor(s) 806 may include on-chip memory 806′. In some aspects, the apparatus 804 may further include a Bluetooth module 812, a WLAN module 814, an SPS module 816 (e.g., GNSS module), one or more sensor modules 818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 826, a power supply 830, and/or a camera 832. The Bluetooth module 812, the WLAN module 814, and the SPS module 816 may include an on-chip transceiver (TRX) (or in some cases, just a receiver (RX)). The Bluetooth module 812, the WLAN module 814, and the SPS module 816 may include their own dedicated antennas and/or utilize the antennas 880 for communication. The cellular baseband processor(s) 824 communicates through the transceiver(s) 822 via one or more antennas 880 with the UE 104 and/or with an RU associated with a network entity 802. The cellular baseband processor(s) 824 and the application processor(s) 806 may each include a computer-readable medium/memory 824′, 806′, respectively. The additional memory modules 826 may also be considered a computer-readable medium/memory. Each computer-readable medium/memory 824′, 806′, 826 may be non-transitory. The cellular baseband processor(s) 824 and the application processor(s) 806 are each responsible for general processing, including the execution of software stored on the computer-readable medium/memory. The software, when executed by the cellular baseband processor(s) 824/application processor(s) 806, causes the cellular baseband processor(s) 824/application processor(s) 806 to perform the various functions described supra. The computer-readable medium/memory may also be used for storing data that is manipulated by the cellular baseband processor(s) 824/application processor(s) 806 when executing software. The cellular baseband processor(s) 824/application processor(s) 806 may be a component of the UE 350 and may include the at least one memory 360 and/or at least one of the TX processor 368, the RX processor 356, and the controller/processor 359. In one configuration, the apparatus 804 may be at least one processor chip (modem and/or application) and include just the cellular baseband processor(s) 824 and/or the application processor(s) 806, and in another configuration, the apparatus 804 may be the entire UE (e.g., see UE 350 of FIG. 3) and include the additional modules of the apparatus 804.

As discussed supra, the profile component 198 may be configured to receive, from a network node, a set of RRC profile messages configuring a set of RRC profiles, where each RRC profile message of the set of RRC profile messages indicates a respective RRC profile of the set of RRC profiles associated with a respective feature of the UE. In some aspects, the profile component 198 may be further configured to communicate with the network node based on at least one RRC profile of the set of RRC profiles. The profile component 198 may be within the cellular baseband processor(s) 824, the application processor(s) 806, or both the cellular baseband processor(s) 824 and the application processor(s) 806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 804 may include a variety of components configured for various functions. In one configuration, the apparatus 804, and in particular the cellular baseband processor(s) 824 and/or the application processor(s) 806, may include means for receiving, from a network node, a set of RRC profile messages configuring a set of RRC profiles, where each RRC profile message of the set of RRC profile messages indicates a respective RRC profile of the set of RRC profiles associated with a respective feature of the UE. In some aspects, the apparatus 804 may include means for communicating with the network node based on at least one RRC profile of the set of RRC profiles. In some aspects, the apparatus 804 may include means for communicating with the network node based on the first set of values for a first feature associated with the first RRC profile. In some aspects, the apparatus 804 may include means for communicating with the network node based on the second set of values for a second feature different from the first feature. In some aspects, the apparatus 804 may include means for removing the RRC profile from the at least one memory based on an expiration of the validity timer or a movement of the UE outside the validity area. In some aspects, the apparatus 804 may include means for receiving, from the network node, an update on the validity timer or the validity area. In some aspects, the apparatus 804 may include means for receiving the set of RRC profile messages in a system information block (SIB), a dedicated RRC signaling, a broadcast channel, or a user plane message. In some aspects, the apparatus 804 may include means for activating the at least one RRC profile of the set of RRC profiles, where each RRC profile message of the set of RRC profile messages indicates a respective activation method associated with the respective RRC profile. In some aspects, the apparatus 804 may include means for receiving a MAC-CE or DCI that indicates the at least one RRC profile. In some aspects, the apparatus 804 may include means for transmitting an indication of the at least one RRC profile to the network node. The means may be the component 198 of the apparatus 804 configured to perform the functions recited by the means. As described supra, the apparatus 804 may include the TX processor 368, the RX processor 356, and the controller/processor 359. As such, in one configuration, the means may be the TX processor 368, the RX processor 356, and/or the controller/processor 359 configured to perform the functions recited by the means.

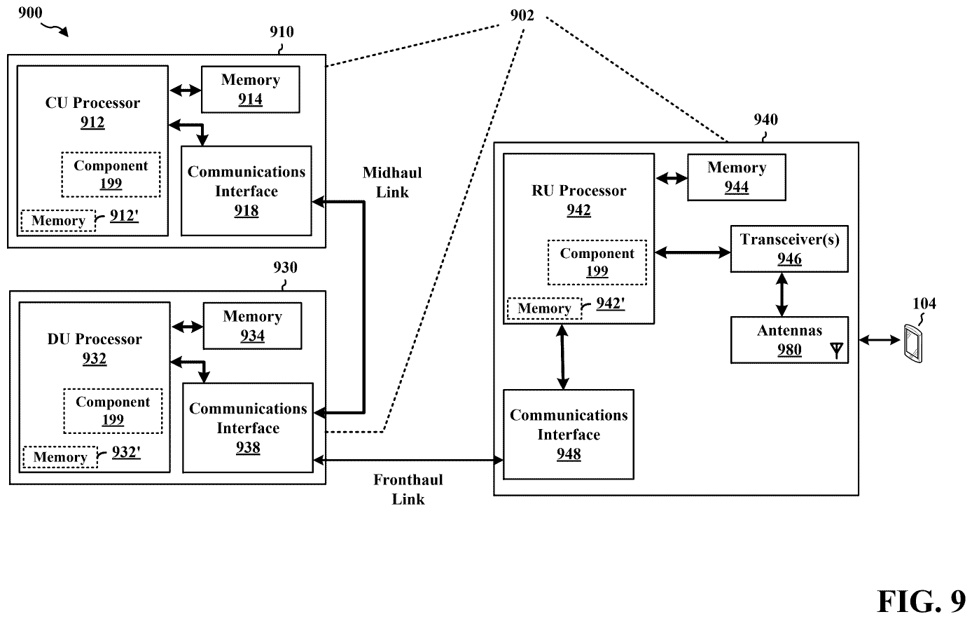

FIG. 9 is a diagram 900 illustrating an example of a hardware implementation for a network entity 902. The network entity 902 may be a BS, a component of a BS, or may implement BS functionality. The network entity 902 may include at least one of a CU 910, a DU 930, or an RU 940. For example, depending on the layer functionality handled by the component 199, the network entity 902 may include the CU 910; both the CU 910 and the DU 930; each of the CU 910, the DU 930, and the RU 940; the DU 930; both the DU 930 and the RU 940; or the RU 940. The CU 910 may include at least one CU processor 912. The CU processor(s) 912 may include on-chip memory 912′. In some aspects, the CU 910 may further include additional memory modules 914 and a communications interface 918. The CU 910 communicates with the DU 930 through a midhaul link, such as an F1 interface. The DU 930 may include at least one DU processor 932. The DU processor(s) 932 may include on-chip memory 932′. In some aspects, the DU 930 may further include additional memory modules 934 and a communications interface 938. The DU 930 communicates with the RU 940 through a fronthaul link. The RU 940 may include at least one RU processor 942. The RU processor(s) 942 may include on-chip memory 942′. In some aspects, the RU 940 may further include additional memory modules 944, one or more transceivers 946, antennas 980, and a communications interface 948. The RU 940 communicates with the UE 104. The on-chip memory 912′, 932′, 942′ and the additional memory modules 914, 934, 944 may each be considered a computer-readable medium/memory. Each computer-readable medium/memory may be non-transitory. Each of the processors 912, 932, 942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the profile component 199 may be configured to transmit, for a UE, a set of RRC profile messages configuring a set of RRC profiles, where each RRC profile message of the set of RRC profile messages indicates a respective RRC profile of the set of RRC profiles associated with a respective feature of the UE. In some aspects, the profile component 199 may be further configured to communicate with the UE based on at least one RRC profile of the set of RRC profiles. The profile component 199 may be within one or more processors of one or more of the CU 910, DU 930, and the RU 940. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 902 may include a variety of components configured for various functions. In one configuration, the network entity 902 may include means for transmitting, for a UE, a set of RRC profile messages configuring a set of RRC profiles, where each RRC profile message of the set of RRC profile messages indicates a respective RRC profile of the set of RRC profiles associated with a respective feature of the UE. In some aspects, the network entity 902 may include means for communicating with the UE based on at least one RRC profile of the set of RRC profiles. The means may be the component 199 of the network entity 902 configured to perform the functions recited by the means. As described supra, the network entity 902 may include the TX processor 316, the RX processor 370, and the controller/processor 375. As such, in one configuration, the means may be the TX processor 316, the RX processor 370, and/or the controller/processor 375 configured to perform the functions recited by the means.

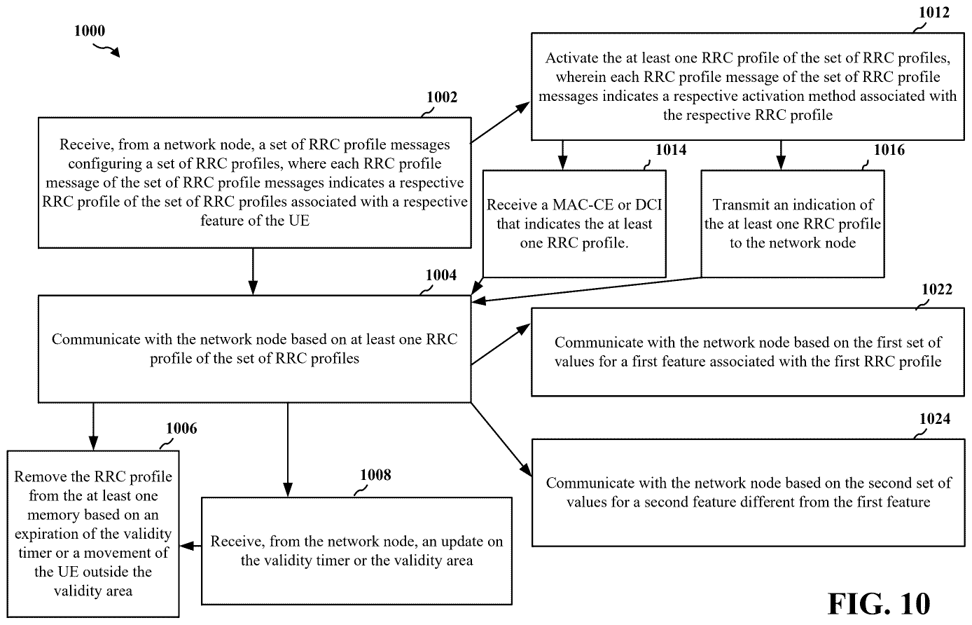

FIG. 10 is a flowchart 1000 of a method of wireless communication. The method may be performed by a UE (e.g., the UE 104, the UE 502; the apparatus 804).

At 1002, the UE may receive, from a network node, a set of RRC profile messages configuring a set of RRC profiles, where each RRC profile message of the set of RRC profile messages indicates a respective RRC profile of the set of RRC profiles associated with a respective feature of the UE. For example, the UE 502 may receive, from a network node 504, a set of RRC profile messages (e.g., 510) configuring a set of RRC profiles, where each RRC profile message of the set of RRC profile messages indicates a respective RRC profile of the set of RRC profiles associated with a respective feature of the UE. In some aspects, 1002 may be performed by profile component 198.

In some aspects, the set of RRC profiles includes a first RRC profile (e.g., 410A) associated with one or more semi-static or periodic channels, a second RRC profile (e.g., 410B) associated with a semi-active or dormant state associated with a secondary cell, a third RRC profile (e.g., 410C) associated with a burst traffic session associated with a QoS, or a fourth RRC profile associated with a non-burst traffic session. In some aspects, the respective feature corresponds to: a CSI-RS configuration, a measurement configuration, a scheduling request configuration, or a random access channel configuration RACH. In some aspects, each RRC profile message of the set of RRC profile messages indicates a respective profile ID associated with the respective RRC profile, and where a first RRC profile message of the set of RRC profile messages indicates a first profile ID associated with a first RRC profile and a parent profile ID associated with the first profile ID, where the parent profile ID is associated with a second RRC profile.

In some aspects, the first RRC profile includes a first set of RRC parameters and the second RRC profile includes a second set of RRC parameters configured to be used in connection with the first set of RRC parameters. In some aspects, the first RRC profile includes a first set of values for the first set of RRC parameters and the second RRC profile includes a second set of values for the first set of RRC parameters.

In some aspects, each RRC profile message of the set of RRC profile messages indicates a respective profile ID associated with the respective RRC profile, where a first RRC profile (e.g., 410A) message of the set of RRC profile messages indicates a first profile ID associated with a first RRC profile, where the first RRC profile includes a first set of RRC parameters and a second RRC profile includes a second set of RRC parameters configured to be used in connection with the first set of RRC parameters, and where the second RRC profile is a common parent RRC profile associated with the set of RRC profiles. In some aspects, each RRC profile message of the set of RRC profile messages indicates at least one respective profile priority associated with the respective RRC profile for override of conflicting values of a same RRC parameter included in different RRC profiles of the set of RRC profiles, and where the at least one respective profile priority is associated with the respective RRC profile or associated with at least one particular RRC parameter of the respective RRC profile.

In some aspects, an RRC profile of the set of RRC profiles is associated with a validity timer or a validity area, and at 1006, the UE (e.g., the UE 502) may remove the RRC profile from the at least one memory based on an expiration of the validity timer or a movement of the UE outside the validity area. For example, 1006 may be performed by the profile component 198. In some aspects, at 1008, the UE (e.g., the UE 502) may receive, from the network node, an update on the validity timer or the validity area. For example, 1008 may be performed by the profile component 198. In some aspects, an RRC profile of the set of RRC profiles is UE-specific and associated with the UE, cell-specific and associated with one or more cells of the network node, or area-specific and associated with a current area that the UE is in. In some aspects, the UE may receive the set of RRC profile messages in a system information block (SIB), a dedicated RRC signaling, a broadcast channel, or a user plane message. In some aspects, each RRC profile of the set of RRC profiles is associated with a respective applicable time period or a respective applicable location.

In some aspects, at 1012, the UE may activate (e.g., at 540) the at least one RRC profile of the set of RRC profiles, where each RRC profile message of the set of RRC profile messages indicates a respective activation method associated with the respective RRC profile. For example, 1012 may be performed by the profile component 198. In some aspects, at least one of the respective activation method corresponds to medium access control (MAC) control element (MAC-CE)-based activation or downlink control information (DCI)-based activation, and the UE may, at 1014, receive a MAC-CE or DCI (e.g., 530) that indicates the at least one RRC profile. For example, 1014 may be performed by the profile component 198. In some aspects, the MAC-CE or the DCI further indicates at least one timeline associated with the at least one RRC profile or a mapping between the at least one RRC profile to at least one logical channels. For example, 1014 may be performed by the profile component 198.

In some aspects, at least one of the respective activation method corresponds to event-based activation based on an event. In some aspects, the event is based on at least one of: (1) an indication of a channel or beam quality or strength based on a reference signal received power (RSRP), a received signal strength indicator (RSSI), a signal to interference and noise ratio (SINR), a channel quality indicator (CQI), a quantity of layers, or an estimated spectral efficiency, (2) a beam failure or a block error rate above a threshold within a window, (3) a buffer status, (4) a power headroom, (5) a mobility state associated with the UE, or (6) one or more timers. In some aspects, at 1016 the UE may transmit an indication (e.g., 550) of the at least one RRC profile to the network node.

At 1004, the UE may communicate with the network node based on at least one RRC profile of the set of RRC profiles. For example, the UE 502 may communicate (e.g., 520 or 560) with the network node 504 based on at least one RRC profile of the set of RRC profiles. In some aspects, 1004 may be performed by profile component 198. In some aspects, at 1022, the UE may communicate (e.g., 520 or 560) with the network node based on the first set of values for a first feature associated with the first RRC profile (e.g., 410A). For example, 1022 may be performed by the profile component 198. In some aspects, at 1024, the UE may communicate with the network node based on the second set of values for a second feature different from the first feature. For example, 1024 may be performed by the profile component 198.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE), including: at least one memory; and at least one processor coupled to the at least one memory, and based at least in part on information stored in the at least one memory, the at least one processor is configured to: receive, from a network node, a set of RRC profile messages configuring a set of RRC profiles, where each RRC profile message of the set of RRC profile messages indicates a respective RRC profile of the set of RRC profiles associated with a respective feature of the UE; and communicate with the network node based on at least one RRC profile of the set of RRC profiles.

Aspect 2 is the apparatus of aspect 1, where the set of RRC profiles includes a first RRC profile associated with one or more semi-static or periodic channels, a second RRC profile associated with a semi-active or dormant state associated with a secondary cell, a third RRC profile associated with a burst traffic session associated with a QoS, or a fourth RRC profile associated with a non-burst traffic session.

Aspect 3 is the apparatus of any of aspects 1-2, where the respective feature corresponds to: a CSI-RS configuration, a measurement configuration, a scheduling request configuration, or a random access channel configuration RACH.

Aspect 4 is the apparatus of any of aspects 1-3, where each RRC profile message of the set of RRC profile messages indicates a respective profile ID associated with the respective RRC profile, and where a first RRC profile message of the set of RRC profile messages indicates a first profile ID associated with a first RRC profile and a parent profile ID associated with the first profile ID, where the parent profile ID is associated with a second RRC profile.

Aspect 5 is the apparatus of aspect 4, where the first RRC profile includes a first set of RRC parameters and the second RRC profile includes a second set of RRC parameters configured to be used in connection with the first set of RRC parameters.

Aspect 6 is the apparatus of aspect 5, where the first RRC profile includes a first set of values for the first set of RRC parameters and the second RRC profile includes a second set of values for the first set of RRC parameters, and where to communicate with the network node, the at least one processor is configured to: communicate with the network node based on the first set of values for a first feature associated with the first RRC profile; or communicate with the network node based on the second set of values for a second feature different from the first feature.

Aspect 7 is the apparatus of any of aspects 1-6, where each RRC profile message of the set of RRC profile messages indicates a respective profile ID associated with the respective RRC profile, where a first RRC profile message of the set of RRC profile messages indicates a first profile ID associated with a first RRC profile, where the first RRC profile includes a first set of RRC parameters and a second RRC profile includes a second set of RRC parameters configured to be used in connection with the first set of RRC parameters, and where the second RRC profile is a common parent RRC profile associated with the set of RRC profiles.

Aspect 8 is the apparatus of any of aspects 1-7, where each RRC profile message of the set of RRC profile messages indicates at least one respective profile priority associated with the respective RRC profile for override of conflicting values of a same RRC parameter included in different RRC profiles of the set of RRC profiles, and where the at least one respective profile priority is associated with the respective RRC profile or associated with at least one particular RRC parameter of the respective RRC profile.

Aspect 9 is the apparatus of any of aspects 1-8, where an RRC profile of the set of RRC profiles is associated with a validity timer or a validity area, and where the at least one processor is further configured to: remove the RRC profile from the at least one memory based on an expiration of the validity timer or a movement of the UE outside the validity area.

Aspect 10 is the apparatus of aspect 9, where the at least one processor is further configured to: receive, from the network node, an update on the validity timer or the validity area.

Aspect 11 is the apparatus of any of aspects 1-10, where an RRC profile of the set of RRC profiles is UE-specific and associated with the UE, cell-specific and associated with one or more cells of the network node, or area-specific and associated with a current area that the UE is in.

Aspect 12 is the apparatus of any of aspects 1-11, where to receive the set of RRC profile messages, the at least one processor is configured to: receive the set of RRC profile messages in a system information block (SIB), a dedicated RRC signaling, a broadcast channel, or a user plane message.

Aspect 13 is the apparatus of any of aspects 1-12, where each RRC profile of the set of RRC profiles is associated with a respective applicable time period or a respective applicable location.

Aspect 14 is the apparatus of any of aspects 1-13, where the at least one processor is further configured to: activate the at least one RRC profile of the set of RRC profiles, where each RRC profile message of the set of RRC profile messages indicates a respective activation method associated with the respective RRC profile.

Aspect 15 is the apparatus of aspect 14, where at least one of the respective activation method corresponds to medium access control (MAC) control element (MAC-CE)-based activation or downlink control information (DCI)-based activation, and where to activate the at least one RRC profile, the at least one processor is configured to: receive a MAC-CE or DCI that indicates the at least one RRC profile.

Aspect 16 is the apparatus of aspect 15, where the MAC-CE or the DCI further indicates at least one timeline associated with the at least one RRC profile or a mapping between the at least one RRC profile to at least one logical channels.

Aspect 17 is the apparatus of any of aspects 14-16, where at least one of the respective activation method corresponds to event-based activation based on an event.

Aspect 18 is the apparatus of aspect 17, where the event is based on at least one of: (1) an indication of a channel or beam quality or strength based on a reference signal received power (RSRP), a received signal strength indicator (RSSI), a signal to interference and noise ratio (SINR), a channel quality indicator (CQI), a quantity of layers, or an estimated spectral efficiency, (2) a beam failure or a block error rate above a threshold within a window, (3) a buffer status, (4) a power headroom, (5) a mobility state associated with the UE, or (6) one or more timers.

Aspect 19 is the apparatus of any of aspects 14-18, where to activate the at least one RRC profile, the at least one processor is configured to: transmit an indication of the at least one RRC profile to the network node.

Aspect 20 is an apparatus for wireless communication at a network node, including: at least one memory; and at least one processor coupled to the at least one memory, and based at least in part on information stored in the at least one memory, the at least one processor is configured to: transmit, for a UE, a set of RRC profile messages configuring a set of RRC profiles, where each RRC profile message of the set of RRC profile messages indicates a respective RRC profile of the set of RRC profiles associated with a respective feature of the UE; and communicate with the UE based on at least one RRC profile of the set of RRC profiles.

Aspect 21 is a method of wireless communication for implementing any of aspects 19 to 19.

Aspect 22 is a computer-readable medium (e.g., a non-transitory computer-readable medium) storing computer executable code, the code when executed by at least one processor causes the at least one processor to implement any of aspects 1 to 19.

Aspect 23 is an apparatus comprising means for implementing any of aspects 1 to 19.

Aspect 24 is a method of wireless communication for implementing aspect 20.

Aspect 25 is a computer-readable medium (e.g., a non-transitory computer-readable medium) storing computer executable code, the code when executed by at least one processor causes the at least one processor to implement aspect 20.

Aspect 26 is an apparatus comprising means for implementing aspect 20.

What is claimed is:

1. An apparatus for wireless communication at a user equipment (UE), comprising:
at least one memory; and
at least one processor coupled to the at least one memory, and based at least in part on information stored in the at least one memory, the at least one processor is configured to:
receive, from a network node, a set of radio resource control (RRC) profile messages configuring a set of RRC profiles, wherein each RRC profile message of the set of RRC profile messages indicates a respective RRC profile of the set of RRC profiles associated with a respective feature of the UE; and
communicate with the network node based on at least one RRC profile of the set of RRC profiles.

2. The apparatus of claim 1, wherein the set of RRC profiles comprises a first RRC profile associated with one or more semi-static or periodic channels, a second RRC profile associated with a semi-active or dormant state associated with a secondary cell, a third RRC profile associated with a burst traffic session associated with a quality of service (QoS), or a fourth RRC profile associated with a non-burst traffic session.

3. The apparatus of claim 1, wherein the respective feature corresponds to: a channel state information (CSI) reference signal (CSI-RS) configuration, a measurement configuration, a scheduling request configuration, or a random access channel configuration (RACH).

4. The apparatus of claim 1, wherein each RRC profile message of the set of RRC profile messages indicates a respective profile ID associated with the respective RRC profile, and wherein a first RRC profile message of the set of RRC profile messages indicates a first profile ID associated with a first RRC profile and a parent profile ID associated with the first profile ID, wherein the parent profile ID is associated with a second RRC profile.

5. The apparatus of claim 4, wherein the first RRC profile comprises a first set of RRC parameters and the second RRC profile includes a second set of RRC parameters configured to be used in connection with the first set of RRC parameters.

6. The apparatus of claim 5, wherein the first RRC profile comprises a first set of values for the first set of RRC parameters and the second RRC profile comprises a second set of values for the first set of RRC parameters, and wherein to communicate with the network node, the at least one processor is configured to:
communicate with the network node based on the first set of values for a first feature associated with the first RRC profile; or
communicate with the network node based on the second set of values for a second feature different from the first feature.

7. The apparatus of claim 1, wherein each RRC profile message of the set of RRC profile messages indicates a respective profile ID associated with the respective RRC profile, wherein a first RRC profile message of the set of RRC profile messages indicates a first profile ID associated with a first RRC profile, wherein the first RRC profile comprises a first set of RRC parameters and a second RRC profile includes a second set of RRC parameters configured to be used in connection with the first set of RRC parameters, and wherein the second RRC profile is a common parent RRC profile associated with the set of RRC profiles.

8. The apparatus of claim 1, wherein each RRC profile message of the set of RRC profile messages indicates at least one respective profile priority associated with the respective RRC profile for override of conflicting values of a same RRC parameter included in different RRC profiles of the set of RRC profiles, and wherein the at least one respective profile priority is associated with the respective RRC profile or associated with at least one particular RRC parameter of the respective RRC profile.

9. The apparatus of claim 1, wherein an RRC profile of the set of RRC profiles is associated with a validity timer or a validity area, and wherein the at least one processor is further configured to:
remove the RRC profile from the at least one memory based on an expiration of the validity timer or a movement of the UE outside the validity area.

10. The apparatus of claim 9, wherein the at least one processor is further configured to:
receive, from the network node, an update on the validity timer or the validity area.

11. The apparatus of claim 1, wherein an RRC profile of the set of RRC profiles is UE-specific and associated with the UE, cell-specific and associated with one or more cells of the network node, or area-specific and associated with a current area that the UE is in.

12. The apparatus of claim 1, wherein to receive the set of RRC profile messages, the at least one processor is configured to:
receive the set of RRC profile messages in a system information block (SIB), a dedicated RRC signaling, a broadcast channel, or a user plane message.

13. The apparatus of claim 1, wherein each RRC profile of the set of RRC profiles is associated with a respective applicable time period or a respective applicable location.

14. The apparatus of claim 1, wherein the at least one processor is further configured to:
activate the at least one RRC profile of the set of RRC profiles, wherein each RRC profile message of the set of RRC profile messages indicates a respective activation method associated with the respective RRC profile.

15. The apparatus of claim 14, wherein at least one of the respective activation method corresponds to medium access control (MAC) control element (MAC-CE)-based activation or downlink control information (DCI)-based activation, and wherein to activate the at least one RRC profile, the at least one processor is configured to:
receive a MAC-CE or DCI that indicates the at least one RRC profile.

16. The apparatus of claim 15, wherein the MAC-CE or the DCI further indicates at least one timeline associated with the at least one RRC profile or a mapping between the at least one RRC profile to at least one logical channels.

17. The apparatus of claim 14, wherein at least one of the respective activation method corresponds to event-based activation based on an event, wherein the event is based on at least one of: (1) an indication of a channel or beam quality or strength based on a reference signal received power (RSRP), a received signal strength indicator (RSSI), a signal to interference and noise ratio (SINR), a channel quality indicator (CQI), a quantity of layers, or an estimated spectral efficiency, (2) a beam failure or a block error rate above a threshold within a window, (3) a buffer status, (4) a power headroom, (5) a mobility state associated with the UE, or (6) one or more timers.

18. The apparatus of claim 14, wherein to activate the at least one RRC profile, the at least one processor is configured to:
transmit an indication of the at least one RRC profile to the network node.

19. A method of wireless communication at a user equipment (UE), comprising:
receiving, from a network node, a set of radio resource control (RRC) profile messages configuring a set of RRC profiles, wherein each RRC profile message of the set of RRC profile messages indicates a respective RRC profile of the set of RRC profiles associated with a respective feature of the UE; and
communicating with the network node based on at least one RRC profile of the set of RRC profiles.

20. An apparatus for wireless communication at a network node, comprising:
at least one memory; and
at least one processor coupled to the at least one memory, and based at least in part on information stored in the at least one memory, the at least one processor is configured to:
transmit, for a user equipment (UE), a set of radio resource control (RRC) profile messages configuring a set of RRC profiles, wherein each RRC profile message of the set of RRC profile messages indicates a respective RRC profile of the set of RRC profiles associated with a respective feature of the UE; and
communicate with the UE based on at least one RRC profile of the set of RRC profiles.
